(19) United States
(12) Patent Application Publication
(10) Pub. No.: US 2011/0015083 A1
(43) Pub. Date: Jan. 20, 2011

(54) Identification of Orthologous Genes

(76) Inventor: John Payin Okyere, Nottinghamshire (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/922,599

(22) PCT Filed: Mar. 12, 2009
(86) PCT No.: PCT/GB09/00662

§ 371 Date: Sep. 14, 2010

(51) Int. Cl. C40B 30/00; C40B 40/06; C40B 60/12; C40B 50/00

(52) U.S. Cl. 506/7; 506/16; 506/39; 506/23

(57) ABSTRACT

A method is disclosed which can be used for the identification of one or more orthologous genes on a microarray, that utilises a microarray derived from a first animal that is used to analyse a corresponding nucleotide sequence from a second animal or a distinct variety of the first animal. The method comprises applying genomic DNA from the second animal, or distinct variety of the first animal, to a microarray derived from the first animal, measuring a background level of hybridisation intensity of the genomic DNA to probes of the microarray, and selecting probes on the microarray for which the hybridisation intensity is greater than a threshold value based on the background level of hybridisation intensity, whereby the selected probes are indicative of orthologous genes.

The present invention relates to an improved method for the identification of orthologous genes in different species or varieties of animal, and the use of such a method in biomedicine, particularly in toxicogenomic and pharmacogenomic studies of humans and animals.

Traditionally, laboratory animals are used for the assessment of safety and toxicology of drugs and pharmaceuticals. This has inherent drawbacks in that the animals are often employed late in the drug development program and genetic variation between the laboratory animal and humans makes extrapolation of data problematic. Furthermore, serious and idiosyncratic adverse drug reactions (ADR) can arise during drug development which can put patients at risk and hinder the progress of late phase clinical trials.

There are many well publicized cases in which drugs were withdrawn from the market because of toxic effects experienced by a small percentage of patients, with a cost of many billions of dollars to the manufacturer and the loss of a helpful drug to individuals not at risk from the side effects.

To overcome these problems, in vitro gene expression technology has been used, such as high density DNA microarrays (WO9710365, EP0853679, U.S. Pat. No. 6,040,138), which can be employed very early in the drug development program, at the pre-clinical stage, thereby saving cost and time. DNA microarray technology enables global gene expression analysis and profiling of toxicological and pharmacological events.

Such events, whether of harm or of benefit to the individual, usually present themselves as clinical endpoints which can be identified by biomarkers. It is therefore possible to predict clinical outcome early in the drug development phase without extensive animal usage.

Unfortunately however there are a number of drawbacks associated with the use of microarrays in this way. One such drawback is that microarrays require complete gene sequences if they are to be used effectively, such as those known for rats, mice, dogs, etc. At present, microarrays are available for only a few animal species and therefore this limits their use as a tool for the discovery and detection of biomarkers in genetically uncharacterised animal species.

To overcome this drawback, comparative genomics approaches have been used in the past, such as that described by Medhora et al., (2002) (Journal of Physiology. Heart and Circulatory Physiology, 282, pp H414-H422) for the hybridisation of porcine cDNA to an array of human cDNA to analyse porcine gene expression. Comparative genomics utilises a phenomenon of genetics whereby the conservation of function across animal species means that experimental results in animal models, given certain restrictions, can generally be applicable to humans (Thomas et al, Environ Health Perspect. 2002; 110 Suppl 6:919-923). This cross-animal species approach can facilitate biomarker discovery in animals that would otherwise be inaccessible to microarray technology, due to the lack of the complete gene sequence.

Unfortunately, significant quantitative and qualitative differences still exist between the human and the animal models used in research, as a result of genetic variation between the human and the laboratory animal. Furthermore there is still a certain degree of randomness in the method of hybridisation, which makes the existing technology unsuitable for human pharmacogenomic or toxicogenomic clinical studies. It also makes the existing technology inappropriate for biomedical applications such as assessment of drug safety and efficacy. The randomness of the approach is disclosed in WO2005/093630, wherein by adjusting the stringency of the hybridisation conditions, or the subsequent washing conditions, the pattern of hybridisation of the labelled DNA to the microarray can be varied. Therefore different oligonucleotides will be selected depending on the conditions used. Even though a skilled person will know how to adjust such conditions this method is by nature quite random, and is therefore less than ideal in terms of accuracy. The result is that the methodology described in WO2005/093630 and other existing technology can only be used for agriculturally or ecologically important plant species.

There have now been devised improvements to known technology that overcome or substantially mitigate the above-mentioned and/or other disadvantages associated with the prior art through an improved method for the identification of orthologous genes. These are genes in different animals that have evolved by speciation from a common ancestral gene. Conserved changes in orthologous gene expression equate to conserved pharmacodynamic endpoints and this means that cross-animal comparative assessment of pharmacogenomic and toxicogenomic gene sequences is now possible. The more informed selection of orthologous genes enables their use in toxicology and efficacy studies in both characterised and uncharacterised animal models, and this allows transcriptomic assessment of drug performance and safety in animal models that lack complete genome sequences. The method further allows the assessment of all molecular differences between animals after drug exposure.

In the first aspect of the invention there is provided a method for the identification of one or more orthologous genes, which method utilises a microarray derived from a first animal that is used to analyse a corresponding nucleotide sequence from a second animal or a distinct variety of the first animal, wherein the method comprises
applying genomic DNA from the second animal, or distinct variety of the first animal, to the microarray derived from the first animal,
measuring a background level of hybridisation intensity of the genomic DNA to probes of the microarray, and
selecting probes on the microarray for which the hybridisation intensity is greater than a threshold value based on the background level of hybridisation intensity,
whereby the selected probes are indicative of orthologous genes.

The background level of hybridisation may be measured by determining the average level of hybridisation intensity to control probes present on the microarray. For instance, the microarray may contain control probes corresponding to certain bacterial genes. These bacterial genes may be negative control probes for RNA sample hybridisation to the microarray. The present invention may use such bacterial control genes, commonly present on microarrays, to estimate the hybridisation background after genomic DNA hybridisation.

The threshold value may be set at a certain predetermined level above the background intensity. For instance, the average value of the hybridisation intensity at the control probes may be taken as the background level, and the standard deviation of the intensities at those probes may also be calculated. The threshold value may then be set at a certain level above the background average, for instance a certain multiple of the standard deviation above the background average, eg three times the standard deviation above that background average.

The first animal may be referred to as the reference animal, and accordingly, the microarray of probes derived from the first animal may also be referred to as the reference animal microarray. The second animal, or distinct variety of first animal, may be referred to as the cross animal. A variety in the context of this invention may represent an animal strain, distinct laboratory subspecies or a transgenic animal.

The corresponding nucleotide sequence in the cross animal may be a part of a larger sequence.

The corresponding nucleic acid sequence is preferably a nucleic acid or nucleic acid sequence that is complementary, or substantially complementary, to one or more of the probes of the microarray and which can therefore under the appropriate conditions hybridise to the microarray. The nucleic acid may be deoxyribonucleotide or a ribonucleotide polymer in either single or double stranded form. The nucleic acid may include natural nucleotides or analogues of natural nucleotides that function in a similar manner. Nucleic acids may be derived from a variety of sources including, but not limited to, naturally occurring nucleic acids, clones, synthesis in solution or solid phase synthesis. A nucleic acid may refer to a polymeric form of nucleotides of any length, the nucleotides may be deoxyribonucleotides, ribonucleotides or peptide nucleic acids (PNAs) that comprise purine and pyrimidine bases or other natural or derivatised nucleotide bases. The sequence of the nucleotides may be interrupted by non-nucleotide components. Examples of nucleic acids which may be used in the invention include genomic DNA, RNA, cDNA and cRNA.

Genomic DNA may be the DNA which comprises the genome of a cell or organism. Genomic DNA may include chromosomal DNA. Genomic DNA may also include non-chromosomal DNA such as mitochondrial DNA. Genomic DNA used in the method of the invention may be fragmented. The genomic DNA used may represent all or just a part of the genome. The genomic DNA may be cloned genomic DNA, which may be in a vector such as a BAC, YAC, PI clone or cosmid.

Probes identified by the method of the invention may then be used in further analysis of nucleic acids from the second animal or distinct variety of the first animal.

Preferably a microarray is used only once as it is difficult to ensure that all the nucleic acid previously applied has been removed. Preferably, one microarray is used with genomic DNA to identify the relevant probes/oligonucleotides, and a second identical microarray is used in subsequent studies using only the identified probes.

In the present invention, probes on a microarray derived from a first animal are used to analyse the corresponding nucleotide sequence from a second animal (cross animal) or a distinct variety of the first animal, to identify genes of the first animal and the second animal that are orthologous. By identifying and selecting the probes on the microarray which hybridise to the genomic DNA of the cross animal, the microarray can be tailored for use with the cross animal. Having identified the probes on the microarray which hybridise to the genomic DNA of the cross animal, a mask may be generated which is specific to those probes. The mask may then be used when the microarray is used to analyse further the gene expression data of the cross animal, to ensure that only the selected probes are included in the analysis. Probes which do not hybridise to the genomic DNA of the cross animal, are therefore not considered in further analysis and thus cannot dilute or influence this analysis.

The use of genomic DNA from the cross animal, to select the probes on the microarray ensures that as far as possible all the genes in the genome of the cross animal, which are present on the array are represented in the probes identified and selected for use in further analysis. By using the genomic DNA to select the probes, the selection is not biased to only the genes expressed in the sample material as all genes are represented in the genomic DNA.

The selected probes may be used to study the pattern of gene expression in the second animal or distinct variety of the first animal, for example, differences in gene expression between different tissues, at different times of development or in response to different environments or conditions, may be analysed.

The selected probes may be used to analyse changes or differences between cross-animal or cross-variety DNA. Such changes may include deletions, chromosome rearrangements, chromosome insertions, polymorphisms such as single nucleotide polymorphisms (SNPs), and RNA changes other than simple gene transcripts.

The method of the invention may be used to identify and select probes which can be used to analyse the transcriptome of the cross animal. The transcriptome may be the full complement of activated genes, mRNA, transcripts or other forms of RNA in a particular tissue at a particular time in the cross animal.

The probes identified by the method of the invention may also be used to produce genetic maps and identify biallelic markers.

Probes selected or identified in the method of the invention may be used as primers for amplification, such as by PCR, or for sequencing. The identified probes may be used as primers for the validation of genome information derived from probe sets.

Microarrays are well known in the art, and those skilled in the art will understand the term. A microarray for use in the invention typically comprises a number of probe sets, each probe set being specific to a gene transcript from the animal from which the array is derived. Each probe set may comprise between about 11 and about 20 probes which bind at various positions on the same gene transcript. The probes may be included as probe pairs, in which each probe pair may comprise a perfect match (PM) and a mismatch (MM) oligonucleotide probe. In the method of the invention, only PM probes may be considered to be informative.

Preferably the probes are from about 15 to about 80 nucleotides in length. More preferably the probes are from about 20 to about 30 nucleotides in length. More preferably the probes are about 25 nucleotides in length. If included, the mismatch (MM) probes preferably have a mismatch base when compared to the gene in the first animal. Preferably, the mismatch is near the middle of the probe.

Once the probes which hybridise to the genomic DNA of the second animal, or a distinct variety of the first animal, have been identified, a mask may be generated defining only those probes which are to be retained, or used in further analysis of the cross animal. By applying the mask to a microarray of the first animal it is effectively converted into a microarray directed to the second animal, or the distinct variety of the first animal.

Hybridisation of genomic DNA to the probes on the microarray may be determined by using genomic DNA which has been labelled, for example with a fluorescent, chemiluminescent or radioactive label, and then screening the microarray for the label to identify probes in the microarray to which the genomic DNA has hybridised. Methods to isolate genomic DNA are well known to those skilled in the art, as are methods to label the DNA. For example the Bioprime DNA labelling system from Invitrogen may be used to label genomic DNA.

The procedure for the hybridisation of genomic DNA to the microarray is as for mRNA and may be as described in DE69625920T. After staining the microarray the microarray is scanned to identify where the genomic DNA has bound, eg as described in DE69625920T. Software that may be used to analyse the microarray is described in detail in U.S. Pat. No. 5,547,839, U.S. Pat. No. 5,578,832 and U.S. Pat. No. 5,631,734. The software generates a hybridisation intensity file (CEL) containing the statistics of the array eg the 75th percentile of intensities, standard deviation of pixel intensities and probe co-ordinates which represent the physical location of the probes on the array.

In embodiments of the invention, each CEL file with hybridisation intensities of genomic DNA from the cross animal is segmented into approximately 500,000 features of probe intensities in pixels. Initially, informative probes are identified as probes with intensity above the background level. The background level is estimated by computing the average signal of bacteria control genes on the GeneChip™. Pixels with extreme intensities may be identified as those whose intensity differs from the background level by more than a predetermined amount. For instance, that predetermined amount may be a multiple of the standard deviation of the background level, eg three times.

Normalisation is effected by an invariant set method across replicate CEL files. An invariant set is identified as a set of probes whose intensity in the experiment CEL intensity is the same as that of the baseline CEL intensity.

The probe set members which are excluded from use in further analysis of the cross animal may themselves provide information about the differences between the first animal and the cross animal, in terms of a single nucleotide polymorphism (SNP), a deletion or mapping studies including the comparative genomics of cross-animal colinearity.

The microarray used may be commercially prepared, such as those made by Affymetrix or Nimblegen.

According to a further aspect the invention provides a method of analysing nucleic acids in a second animal, or a distinct variety of a first animal, using a microarray from a first animal, which method comprises
identifying and selecting, by the method of the first aspect of the invention, probes indicative of orthologous genes,
applying mRNA, cDNA or cRNA from a tissue of the second animal, or distinct variety of the first animal, to a microarray derived from the first animal, and
analysing the pattern of hybridisation of the mRNA, cDNA or cRNA to the selected probes.

This method may be used to study gene expression in the second animal, or distinct variety of the first animal, using a microarray from the first animal.

Preferably the mRNA, cDNA and/or cRNA is labelled before use. The label may be a fluorescent, chemiluminescent or radioactive label.

By analysing the pattern of hybridisation of the mRNA, cDNA or cRNA to the selected probes, the genes which are expressed, and those which are not expressed, in the tissue from the cross animal, can be determined. This method allows the transcriptome of a cross animal to be studied using a microarray derived from a first animal.

According to another aspect, the invention provides the use of the probes identified according to the first or second method of the invention to study gene expression in a second animal, or a distinct variety of a first animal.

The selected probes may also be used to study changes in gene structure between a first animal and a second animal, or a distinct variety of the first animal. The changes may include deletions, insertions or mutations.

According to a further aspect the invention provides a kit for selecting oligonucleotides on a microarray comprising a microarray derived from a first animal and instructions to use the method of the invention with genomic DNA of a second animal or a distinct variety of the first animal.

According to a further aspect the invention provides a kit for analysing gene expression in a second animal or a distinct variety of a first animal, the kit comprising a microarray derived from a first animal and instructions to use the microarray according to the method of the invention.

An advantage of the method of the invention is that a microarray already available can be tailored for use with an animal or a variety for which a microarray is not available. Microarrays are currently only available for a small number of animal species, and the production of a microarray for a specific animal can be very expensive and can take several years to accomplish.

To further analyse the CEL data to generate probe masks, which determine which probes should be considered in subsequent analysis, the computer language PERL (see eg Wall Christiansen and Orwant, Programming Perl, 3rd Ed, O'Reilly and Associates (2000)) is typically used to construct the necessary computer programs, though equivalent scripts and programs can readily be developed in other computing languages (including, but not limited to, C++, Java, Visual Basic).

First a Perl script is constructed to extract probe co-ordinates with a hybridisation intensity above the threshold value.

A second Perl script may be developed to eliminate mismatch probes with hybridisation intensity above the threshold value and with higher hybridisation intensity than perfect match probes.

A third Perl script may be constructed to complete the process of generating a chip description file (CDF) for the cross-animal.

All the software used in the computation of gene expression levels requires a hybridisation intensity file (CEL) of the type described above and a chip description file (CDF) for the array type carrying the hybridised target transcripts. The chip description file is a library file consisting of gene (probe set) IDs, the corresponding co-ordinates of their probe sequences on the array and other software parameters.

The first animal CDF will normally have been derived by a commercial vendor such as Affymetrix and made available to the general public from their website and on media distributed with their GeneChips® for use in analysing their proprietary material.

A BLAST (Alschul et al., J. Mol. Biol. 215; 403-410 (1990)) output file may be generated in silico by comparing cross animal nucleic acid sequence in a database to nucleic acid sequences represented on the microarray. This output file may be parsed with another Perl script to identify oligonucleotide probes with a specified degree of sequence identity to the cross-animal sequence. The probe selected may then be used to construct a chip description file for the cross-animal organism as described above. Most commonly, the selected probes will be those with 100% sequence identity to cross-animal cDNA, though the required degree of homology may in some circumstances be lower.

By applying the CDF to the reference animal microarray, in effect a virtual cross-animal microarray is generated. The probes of the reference animal microarray that are not selected are masked. In another aspect of the invention, there is thus provided a method for the generation of a microarray specific to a second animal, or distinct variety of a first animal, using a microarray from a first animal, which method comprises the steps of
identifying and selecting probes of the microarray that are indicative of orthologous genes, and
generating a chip description file that includes the coordinates of the selected probes.

The identification and selection of probes indicative of orthologous genes may be performed by the method according to the first aspect of the invention or, where the sequences of the microarray probes and of the DNA of the second animal (or distinct variety of first animal) are known, by sequence comparison as described above.

The CDF generated may be used to construct species-specific microarrays. The CDF file contains the coordinates of the selected probes, the sequences of which may be known. Hence, it is possible to create a microarray by tiling the sequences of the selected probes onto a suitable substrate, eg a glass slide. Thus, according to a further aspect, the invention provides a method of generating a microarray that is specific for a given species, which method comprises depositing probes identified by the method of the first aspect upon a substrate. In such a method, the probes deposited upon the substrate are a subset of probes present on a microarray from a first animal, that subset comprising probes selected as being indicative of genes that are orthologous between the first animal and the given species for which the new microarray is intended to be specific.

The invention allows the informed selection of probe pairs (putative or actual match and mismatch) to allow high throughput genome-wide screening of the expression patterns of genes from genomes of animals related to but not identical to the genome of at least one reference extensively-sequenced animal, eg mouse, human, chimpanzee, chicken and rat.

A computer system for selecting oligonucleotide probes is required. Briefly, a co-ordinate extraction means is arranged to extract the co-ordinates of probes on a microarray derived from a first animal to which genomic DNA from a second animal, or a distinct variety of the first animal, has been applied which display a hybridisation intensity with the genomic DNA that is above the threshold value to generate a match co-ordinate output. A mismatch elimination means is arranged to identify and eliminate mismatch probes with a higher hybridisation intensity than perfect match probes from the match co-ordinate output to generate a perfect match co-ordinate output. A chip description file (CDF) generation means is arranged to compare the first animal CDF with the perfect match co-ordinate output and to generate a further CDF comprising the co-ordinates present in both the first animal CDF and the perfect match output.

The further CDF may be used as a mask in further analysis of the cross animal, which determines which probes on the microarray of the first animal are to be considered.

A mask is generated by the computer system. Briefly, a reader is arranged to detect where genomic DNA has hybridised to a probe on a microarray and to produce data indicative of where hybridisation has occurred. A processor arranged to combine the data from the reader with a CDF for the microarray to produce a mask.

Preferably the data generated by the reader is a set of co-ordinates corresponding to the probes which hybridised to the genomic DNA.

Preferably the mask is a computer program arranged to operate a reader, so that when the mask is applied the reader only considers specific coordinates on a microarray which correspond to probes which hybridised to the genomic DNA. The mask may alternatively be defined as a further CDF.

The mask may be used to tailor a microarray from a first animal to a different animal, or distinct variant of the first animal. By considering only those probes which hybridised to the genomic DNA, subsequent analysis is not diluted by the inclusion of probes that will not bind to DNA of the second animal or the distinct variant of the first animal.

Preferably the reader is a device with the capacity to analyse all the probes on a microarray. Each probe on the microarray has unique coordinates. Preferably any nucleic acid, for example genomic DNA, mRNA, cDNA or cRNA, added to the array is labelled so that the reader can detect where hybridisation to a probe on the array has occurred.

A data carrier may be provided for carrying data arranged to control a computer system to carry out a method according to the invention or to operate as a computer system according to the invention.

Those skilled in the art will appreciate that preferred aspects of the invention discussed with reference to only one aspect of the invention may be applicable to other aspects of the invention.

In another aspect of the invention there is provided the use of the method of the invention for the selection of one or more orthologous genes in different animals for the identification of pharmacogenomic and toxicogenomic biomarkers.

An example of a typical biomarker includes the genes coding for cytochrome P450, a metabolic enzyme found in liver cells. If the chemical also causes liver damage, scientists might hypothesize that activated P450 is involved in the toxic response mechanism. The gene expression profile for activated P450 is therefore a potential biomarker for chemically induced injury to the liver.

Other biomarkers include, but are not limited to, proteins, carbohydrates, fats, and minerals. Biomarkers may also include reactive drug metabolites which bind important cellular proteins and disrupt cellular function.

Pharmacogenomics is the branch of pharmacology which deals with the influence of genetic variation on drug response in patients by correlating gene expression or single-nucleotide polymorphisms with a drug's efficacy.

Toxicogenomics is the branch of toxicology which deals with the influence of genetic variation on drug response in patients by correlating gene expression or single-nucleotide polymorphisms with toxicity.

Both pharmacogenomics and toxicogenomics may include a form of analysis by which the activity of a particular toxin or chemical substance on living tissue can be identified based upon a profiling of its known effects on genetic material.

Preferably the method according to the invention can be used in studies to investigate the activity of genes in different animals when the different animals have been challenged with disease, pathogen, mutagen, vaccine, or other intervention.

The invention may be used for studying genes that are expressed or repressed or genes that are expressed during a particular stage of animal development.

In another aspect of the invention there is provided the use of the method of the invention for the identification of one or more orthologous genes in different animals as a preventative measure to predict adverse side effects of pharmaceutical drugs on susceptible individuals, eg toxicity or other deleterious effects.

In another aspect, the invention may also be used in the development and production of animal, human and veterinary pharmaceuticals, vaccines, and drug therapeutic agents.

For instance, a microarray for a particular species may be used to investigate levels of gene expression in that species. Changes in the gene expression profile following administration of a test substance may be monitored, and may be indicative of toxicological events. The method of the invention enables such studies to be focused on those genes that are orthologous between the test animal (eg rat) and the animal in which the test substance is destined to be used (eg human), thereby increasing the level of confidence that the results observed on the test array, ie in preclinical testing, will be consistent with those observed in clinical practice.

The invention may also be used for the identification of diagnostics through safety biomarker gene expression or signature biomarkers. Using such methods, it would then be possible to test an individual patient for his or her susceptibility to these adverse effects before administering a drug. Patients that would show the marker for an adverse effect would be switched to a different drug.

The benefit of this aspect of the invention is that it would re-allow the therapeutic use of a previously banned drug, prevent potentially life-threatening side effects, and restore the majority of the lost market share of these drugs to the company that developed them.

Another diagnostic aspect would be the identification of safety biomarkers in genetically uncharacterised animals, for the prediction of drugs that are likely to fail at the clinical stage. The major advantage of such an approach would be to facilitate early attrition of therapeutics in a drug discovery program, thereby saving cost.

In another aspect of the invention there is provided the use of the method of the invention and one or more orthologous genes for the identification of diagnostics through safety biomarker gene expression or signature biomarkers.

The invention will now be described by way of example with reference to the following Examples and Figures, in which:

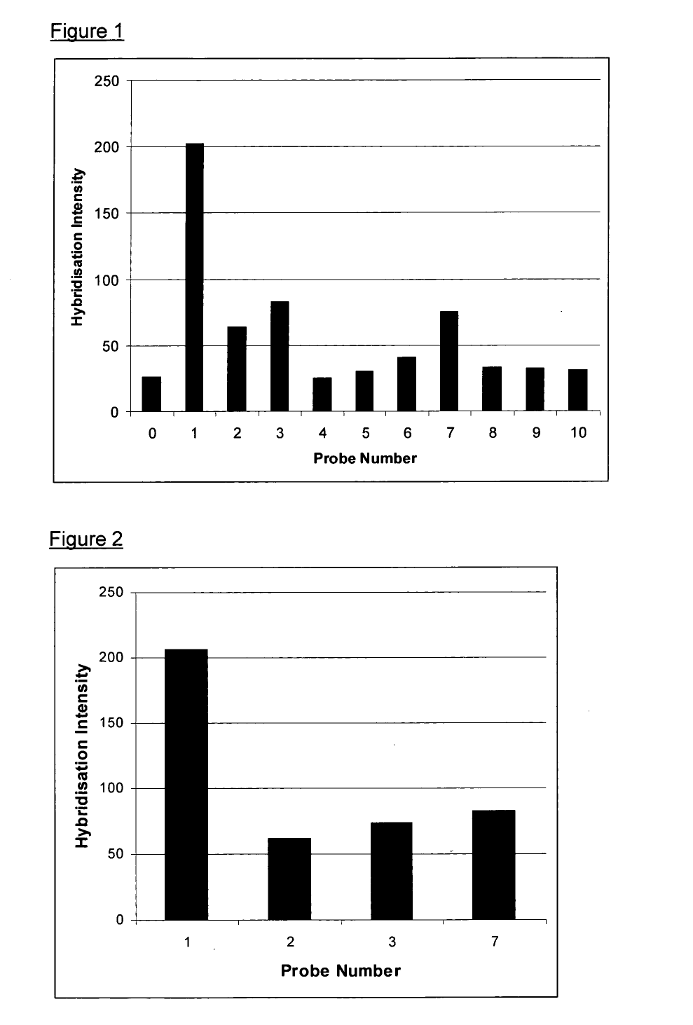

FIG. 1 shows hybridisation intensities for perfect match probes of one probe set of a commercially available human microarray treated with equine cRNA;

FIG. 2 shows similar data to FIG. 1, but restricted to probes corresponding to human_equine orthologous genes.

### EXAMPLE 1

### Identification of Human Equine Orthologous Genes and Generation of a Corresponding Microarray Chip Description File (CDF)

This experiment utilised a commercially available microarray containing human DNA probe sets. The particular microarray used for the experiment was the HG-U133_Plus 2.0 GeneChip™ probe array (Affymetrix Inc, Santa Clara, Calif., USA).

Genomic equine DNA was labelled with a fluorescent marker, using the Bioprime® DNA labelling system (Invitrogen).

The labelled equine DNA was hybridised to the probe sets on the HG-U133 microarray in a conventional manner, eg by the procedure described in DE69625920T. After further washing procedures, the microarray was scanned for areas where equine DNA hybridised to the HG-U133 probe sets, as indicated by a fluorescent signal. Fluorescence intensity (in arbitrary units) was proportional to the degree of hybridisation, and was converted into a hybridisation intensity file (CEL file) which contained statistics of the 75 percentile of intensities, standard deviation of pixel intensities and probe coordinates which represent the physical location of the probes on the array. A different CEL file was generated for each subsequent replicate microarray.

On each microarray, a set of control probes isolated from bacterial genes were also present. These probe sets were treated and washed in the same way as all the other probe sets on the microarray, and were used to calculate the background level of hybridisation intensity. The mean and standard deviation of the background fluorescent intensities at the control probes was calculated, and a “threshold level” was set, corresponding to the mean background intensity plus three times the standard deviation. Probes on the microarray with intensities greater than this threshold level were regarded as informative, ie to correspond to orthologous genes.

By way of illustration, for the eleven perfect match probes present in the probe set designated 1569385_s_at of the HG-U133 human array, four of the eleven probes exhibited intensities greater than the threshold level, namely the probes denoted 1, 2, 3 and 7. These probes were therefore identified as being informative probes corresponding to orthologous human_equine genes. In reality, the microarray contains approximately 55,000 such probe sets, each of which is subjected to similar analysis.

A Chip Description File (CDF) was then created using the selected perfect match probes. The CDF file consisted of a library file of informative probe set ID's and the corresponding co-ordinates on the microarray.

### EXAMPLE 2

### Validation of Selection of Human Equine Orthologous Probes

The same microarray as was used in Example 1 was treated with equine cRNA, and hybridisation intensity at each perfect match probe of the 1569385_s_at probe set was measured.

FIG. 1 shows the hybridisation intensities at those eleven perfect match probes.

Each bar represents the fluorescence intensity at a probe. As can be seen, the four probes with the greatest intensities are those denoted 1, 2, 3 and 7, ie the probes selected in Example 1 that are identified as being informative probes corresponding to orthologous human_equine genes.

The degree of hybridisation of the applied cRNA with the complete probe set was characterised in terms of a “Call” parameter denoted “P” if the degree of hybridisation indicates the presence of the corresponding transcript in the applied sample and “A” if the transcript is absent. In this case, the “Call” is “A”, denoting absence of the transcript.

The above experiment was repeated, but on this occasion the CDF derived in Example 1 was applied to hybridisation data from the microarray, such that only the selected probes were interrogated, the remaining probes being disregarded.

FIG. 2 shows the results for the selected perfect match probes of the 1569385_s_at probe set (ie probes 1, 2, 3 and 7 only). In this case, the “Call” parameter was “P”, indicating that the applied sample contained the transcript of those selected probes.

### EXAMPLE 3

### Identification of Rat Human Orthologous Probes

An orthologous (RG_U34A-Hum) array was generated by selecting orthologous RG_U34A GeneChip™ probes with high homology to human cDNA sequences, by sequence comparison of human cDNA to the rat GeneChip™ probe sequences, identifying those probes with 100% identity to human cDNA sequences, generating a corresponding CDF, and using that CDF as a mask applied to the commercially available RG_U34A GeneChip™, thereby generating the rat_human microarray (denoted RG_U34A-Hum).

Measurements were made of fluorescence intensities for a representative selection of probe sets on the RG_U34A GeneChip™, for the complete probe sets (containing 16 pairs of probes) and for only those probes identified as being indicative of orthologous genes. The number of such informative probes in the chosen probe sets varied from 2 to 9.

The results are shown in Table 1. As can be seen, the measured signal intensities when the measurement is restricted to the informative probes is uniformly higher than when the complete probe sets were interrogated. The higher hybridization signals of the orthologous array (RG_U34A-Hum) indicate improved sensitivity by the selection of orthologous sets of probes with pharmacodynamic properties. This enhanced sensitivity is attributed to reduced biological/genetic variability inherent in cross-animal extrapolation during pre-clinical drug assessment.

The data illustrates that high level expression values are generated with the cross-animal CDF. Since the mean of perfect match and mismatch probe pairs in a probe set is output by the software as the expression estimate of transcripts, probes in the RG_U34A-Hum which are not responsive to Rat transcripts will lead to an attenuation of signal for the probe set, generating an inaccurate expression estimate of the transcript. In a typical experiment the background signal is usually less than 100. Therefore transcripts with expression levels below background are usually identified as undetectable in the sample being interrogated.

TABLE 1

| | RG_U34A | | RG_U34A-Hum | |
|---|---|---|---|---|
| | No of Probe | | No of Probe | |
| Probe set | Pairs | Signal | Pairs | Signal |
| U09361_s_at | 16 | 62.5 | 2 | 158.7 |
| AF065432_s_at | 16 | 21.4 | 3 | 44.5 |
| rc_Al237836_g_at | 16 | 720.5 | 4 | 919.5 |
| M15474cds_s_at | 16 | 168.4 | 4 | 268.2 |
| U39549_g_at | 16 | 42.1 | 5 | 92.6 |
| Rc_AA875146_s_at | 16 | 218.9 | 6 | 618 |
| Y09332cds_s_at | 16 | 56.7 | 6 | 364.6 |
| Rc_AA893673_s_at | 16 | 51.8 | 7 | 120.5 |
| S81497_i_at | 16 | 683.6 | 7 | 1410.7 |
| AF080468_at | 16 | 61.9 | 8 | 104.4 |
| AF048828_g_at | 16 | 144 | 9 | 358.2 |
| S39221_g_at | 16 | 38.2 | 9 | 132.6 |

1. A method for the identification of one or more orthologous genes, which method utilizes a microarray derived from a first animal that is used to analyze a corresponding nucleotide sequence from a second animal or a distinct variety of the first animal, comprising the steps of:
a) applying genomic DNA from the second animal, or distinct variety of the first animal, to the microarray derived from the first animal,
b) measuring a background level of hybridization intensity of the genomic DNA to probes of the microarray, and
c) electing probes on the microarray for which the hybridization intensity is greater than a threshold value based on the background level of hybridization intensity,
whereby the selected probes are indicative of orthologous genes.

2. The method of claim 1, wherein the background level of hybridization is measured by determining the average level of hybridization intensity to control probes present on the microarray.

3. The method of claim 2, wherein the control probes correspond to bacterial genes.

4. The method of claim 2, wherein the average value of the hybridization intensity at the control probes is taken as the background level, and the standard deviation of the intensities at those probes is also calculated, and the threshold value is set at a multiple of the standard deviation above the background level.

5. The method of claim 1, wherein the probes are from about 15 to about 80 nucleotides in length, about 20 to about 30 nucleotides in length, or about 25 nucleotides in length.

6. The method of claim 1, further comprising the step of generating a mask defining only those probes which are to be retained, or used in further analysis of the cross animal.

7. The method of claim 1, wherein the genomic DNA from the second animal, or distinct variety of the first animal, is labelled.

8. The method of claim 7, wherein the genomic DNA is labelled with a fluorescent, chemiluminescent or radioactive label.

9. A method of analyzing nucleic acids in a second animal, or a distinct variety of a first animal, using a microarray from a first animal, comprising the steps of:
a) identifying and selecting, by the method of claim 1, probes indicative of orthologous genes,
b) applying mRNA, cDNA or cRNA from a tissue of the second animal, or distinct variety of the first animal, to a microarray derived from the first animal, and
c) analysing the pattern of hybridization of the mRNA, cDNA or tRNA to the selected probes.

10. The method of claim 1, to predict adverse side effects of pharmaceutical drugs on susceptible individuals.

11. The method of claim 1, for the identification of diagnostics through safety biomarker gene expression or signature biomarkers.

12. The method of claim 1, for the study of gene expression in a second animal, or a distinct variety of a first animal.

13. A kit for selecting oligonucleotides on a microarray, the kit comprising a microarray derived from a first animal and instructions to use the method of claim 1 with genomic DNA of a second animal or a distinct variety of the first animal.

14. A kit for analyzing gene expression in a second animal or a distinct variety of a first animal, the kit comprising a microarray derived from a first animal and instructions to use the kit in a method of claim 12.

15. A computer system for carrying out the method of claim 1, comprising a co-ordinate extraction means to extract the co-ordinates of probes on a microarray derived from a first animal to which genomic DNA from a second animal, or a distinct variety of the first animal, has been applied which display a hybridisation intensity with the genomic DNA that is above the threshold value to generate a match co-ordinate output.

16. The computer system of claim 15, further comprising a chip description file (CDF) generation means.

17. A data carrier carrying data arranged to control the computer system claim 15, to carry out a method for the identification of one or more orthologous genes, which method utilizes a microarray derived from a first animal that is used to analyze a corresponding nucleotide sequence from a second animal or a distinct variety of the first animal, comprising the steps of:
a) applying genomic DNA from the second animal, or distinct variety of the first animal, to the microarray derived from the first animal,
b) measuring a background level of hybridization intensity of the genomic DNA to robes of the microarray, and
c) electing probes on the microarray for which the hybridization intensity is greater than a threshold value based on the background level of hybridization intensity,
whereby the selected probes are indicative of orthologous genes.

18. A method for the generation of a microarray specific to a second animal, or distinct variety of a first animal, using a microarray from a first animal, comprising the steps of
a) identifying and selecting probes of the microarray that are indicative of orthologous genes, and
b) generating a chip description file that includes the coordinates of the selected probes.

19. The method of claim 18, wherein the identification and selection of probes indicative of orthologous genes is performed by a method for the identification of one or more orthologous genes, which method utilizes a microarray derived from a first animal that is used to analyze a corresponding nucleotide sequence from a second animal or a distinct variety of the first animal, comprising the steps of:
a) applying genomic DNA from the second animal, or distinct variety of the first animal, to the microarray derived from the first animal,
b) measuring a background level of hybridization intensity of the genomic DNA to probes of the microarray, and
c) electing probes on the microarray for which the h bridization intensity is greater than a threshold value based on the background level of hybridization intensity,
whereby the selected probes are indicative of orthologous genes.

20. The method of claim 18, wherein the identification and selection of probes indicative of orthologous genes is performed by comparing the sequences of the microarray probes and of the DNA of the second animal, or distinct variety of first animal.

21. A method of generating a microarray specific for a given species, comprising the step of depositing probes identified by the method of claim 1.
